(19) United States
(12) Patent Application Publication
(10) Pub. No.: US 2003/0033159 A1
(43) Pub. Date: Feb. 13, 2003

(54) Interface module for document-based electronic business processes based on transactions

(76) Inventor: Piero Altomare, Rothenburg (CH)

Correspondence Address: FITZPATRICK CELLA HARPER & SCINTO, 30 ROCKEFELLER PLAZA, NEW YORK, NY, 10112, US

(21) Appl. No.: 09/996,882

(22) Filed: Nov. 30, 2001

(30) Foreign Application Priority Data
Oct. 8, 2001 (EP) 01123991.0
Aug. 13, 2001 (EP) 01119457.8

(51) Int. Cl. G06F 17/60

(52) U.S. Cl. 705/1

(57) ABSTRACT

An interface module is used for carrying out transaction-based electronic commerce. The interface module (1) is connected between a terminal (4) and a data network (8), such as the internet for example, in this case. Also provided is a module (1, 3) for displaying (14) and monitoring the flow of useful data (5, 6) to and from the terminal (4), the display module accessing document templates (12) to allow the useful data transmitted to be displayed as documents.

A further aspect is that an interface system is provided for connecting systems, heterogeneous ones where required, together via a data network, the system having interface modules which represent the link between the possibly heterogeneous systems, and the data transmission being performed on the basis of transactions by means of defined communications states at the transmitting and receiving ends.

An interface for transmitting useful data on a data network has in this case:

a company- and/or sector-specific configuring object which defines processes,

a template object which defines format templates for documents which are used for carrying out business processes defined in the configuring object, and

an interface object which assigns destinations on the data network intended for given processes, to act as partners in the processes.

### BACKGROUND OF THE INVENTION

1. Field of the Invention

The present invention relates to interface modules for carrying out document-based electronic business processes based on transactions, to computer software programs for implementing such interface modules, to methods of managing the flow of useful data between a terminal and a data network, and to a system for carrying out electronic business processes based on transactions.

The invention relates generally to the carrying out of document-based electronic business processes. Examples of document-based electronic business processes of this kind are the provision of financial services, the logistics field, etc.

Nowadays, a general problem that exists is that various companies that would like to carry out e-commerce, such as ones connected to the internet for example, do not meet any harmonised requirements in respect of their software. The technology for overcoming this problem is often referred to as EDI (electronic data interchange). To be more exact, what is meant by this is the electronic transmission of business data. The object of EDI is to make it possible for business processes to be controlled beyond corporate boundaries. EDI is intended to replace the vast numbers of hard-copy documents, such as orders, acknowledgements, job sheets, invoices, consignment notes and so on, that arise in the course of a business process. EDI implies an electronic interchange of documents of formatted structures that can be further processed on computer systems. The contents of an EDI message must be so formatted that the computers of other companies can make further use of it. Because standardised data formats are employed, both the software solutions used by the communicating parties and the hardware platforms can come from different manufacturers. Since the data is interchanged solely in standardised formats, each company has to map its internal format over onto the standard data format used (e.g. EDIFACT) only once.

EDIFACT (Electronic Data Interchange for Administration, Commerce and Transport) is an international, all-sector standard for the interchange of structured electronic data between DP applications of different parties doing business with one another. EDIFACT can be used without any problems in all existing data-processing systems because it is not tied to any one manufacturer, system or way of transmission. By allowing existing company-specific file structures to be preserved, EDIFACT makes it possible for all companies to accelerate the flow of information and capital when doing business and to break down barriers to trade all over the world.

EDI can speed up the flow of transactions between parties doing business with one another by replacing the conventional paper-based work done to handle jobs and for billing purposes. With EDI, business activities are automated and processes that extend beyond the company itself are speeded up. In “integrated EDI” the application systems of the two parties communicating with each other are connected together. Information which is generated by one of the two parties doing business crosses into the application system of the other party.

In the context of business-to-business and consumer-to-business applications, the interaction is referred to as “WebEDI”. Small and medium-sized companies therefore form a group with private individuals because their dataprocessing facilities and options correspond. Because the internet is used, the communications relationships of the players are concentrated into groups. This grouping function takes two forms, in the one case the grouping of individual transactions into a file and in the other the grouped connection of the users to an application system. To allow efficient use to be made of its existing EDI interface, a company supplies its small and medium-sized business partners with “input templates” on internet pages. This makes it possible for the business partners to input their orders and invoices or, to their banks, instructions for money transfers. At the time of inputting, semantic checks which depend on the intelligence of the “input templates” can be made to ensure that only objectively correct sets of data are stored. The data sets can be buffer-stored on the web server and then transmitted to the recipient at a preset time. The recipient receives an EDI file which he can process with his existing EDI interface (batch-oriented transmission). He can be sure in this case that all the requisite details are present in the individual data sets. The possibility also exists of the data being despatched to the recipient as soon as a document has been fully entered (transaction- or document-oriented transmission).

What promises to be an advantageous development is the combination of EDI with XML. The meaning of XML (Extensible Markup Language) in the e-commerce environment is a data format for the structured interchange of information. XML is being further developed under the aegis of the W3C and the consensus view in the industry is that it will be the next generation architecture for the worldwide web. XML employs the concept of generic markup: tags structure a document by nesting elements within it. HTML is the best known example of this technique. Whereas HTML consists of a fixed set of tags, XML allows an application-oriented vocabulary to be defined. A vocabulary of this kind is defined by a “document type definition” (DTD), a formal grammar that defines tags and the structural relationships between them. DTDs are available for a vast number of areas of application including, amongst others, electronic commerce (OTP, XML-EDI, etc.).

In view of the above problems, the object of the present invention is to provide an interface technology which simplifies the carrying out of document-based electronic commerce. The intention is in particular to also make a document transfer between heterogeneous systems possible. At the same time the intention is furthermore to improve the management of the flow of useful data by means of an interface which connects a corporate terminal to a data network (the internet) and thus to other interfaces of the same kind.

This object is achieved in accordance with the invention by virtue of the features detailed in the independent claims. The dependent claims represent particularly advantageous refinements of the central concept of the invention.

As a first aspect of the present invention, an interface module is provided for carrying out transaction-based electronic commerce. The interface module is connected in this case between a terminal, belonging to a company for example, and a data network, such as the internet for example. The interface module in turn has a module for displaying and monitoring the flow of useful data to and from said terminal. In accordance with the invention, the display and monitoring which takes place in this case is document-based.

The interchanged useful data may for example be shown on a monitor as a document by means of an interpreter application.

Also provided are means for the manual and/or automatic release and/or selection for transmission to or from the terminal of displayed useful data.

Finally, means are provided for selecting data to be transmitted for subsequent transfer to the terminal and/or an address on the data network.

The selection can be performed by reference to a display as a document of the useful data to be transmitted.

The interface module may be configurable from a central intelligence (master server) on the data network, which may for example be an internet platform server.

The interface module may have a file system in which, by means of document templates, a workflow is mapped for a business process which is to be dealt with by means of an interchange of useful data via the interface module.

The document templates can be entered in the file system of the interface module, or modified there, from a central intelligence (master sever) on the data network.

If there is a change to the configuration of the interface module, parameters of processes thereby affected in the workflow mapped by means of document templates can be automatically adjusted.

The document templates and/or a complete workflow may be capable of being coupled to predetermined destinations on the data network by means of a mapping unit (“cross-bar”) in a database.

The present invention further relates to a computer software program for implementing an interface module of this kind.

As a further aspect of the present invention, a method of carrying out electronic transaction-based commerce is provided. In this case an interface module is connected between a terminal, belonging for example to a company which would like to carry out e-commerce, and a data network such as the internet for example. In accordance with the invention, document-based display and monitoring of the flow of useful data to and from the terminal takes place in this case.

The useful data interchanged can be displayed on a monitor as a document by means of an interpreter application.

Useful data that is displayed can be released and/or selected for transmission manually and/or automatically.

In particular, useful data to be transmitted can be selected for subsequent transfer. The selection can be performed by reference to a display as a document of the useful data to be transmitted.

The interface module can be configured from a central intelligence on the data network. A workflow for a business process which is to be dealt with by the interchange of useful data via the interface module can be mapped in a file system by means of templates.

The document templates can be entered in the file system, or modified there if required, from a central intelligence (master server) on the data network.

If there is a change to the configuration of the interface module (a change in access authorisation for example), parameters of processes thereby affected in the workflow mapped by means of document templates can be automatically adjusted.

The document templates and/or a complete workflow can be coupled to predetermined destinations on the data network by means of a mapping unit (cross-bar).

In accordance with the invention, a computer software program for implementing a method of this kind is also provided.

As a further aspect of the present invention, an interface module is provided for displaying the flow of data between a terminal and a data network, such as the internet for example. The interface module has a monitoring layer in this case for displaying and monitoring the flow of useful data to and from the terminal. A logic layer is used for interpreting, converting and transferring data to the terminal and/or data network. Stored in a file layer are templates, with an interpreter application editing incoming and/or outgoing useful data to and/or from the logic layer by means of these templates to allow the useful data to be displayed in the form of documents.

Also provided in accordance with the invention is an interface module for displaying the flow of data between a terminal and a data network, such as the internet for example. A presentation layer is used in this case for generating and showing preset document screens on the basis of useful data which is to be transferred by means of the interface. A business layer is used to control processes for transmitting and receiving useful data. Finally, a file layer is used to check accesses to a database in which useful data is stored.

The business layer can also generate a workflow by means of a preset sequence of documents.

A facility for remote maintenance of the interface module by means of access to the business layer can be provided.

The business layer may also perform a data conversion function.

The business layer may perform the function of a user access control system.

The file layer may include a function for distinguishing between useful process data, data holdings and configuration data.

The interface module may be connected to a database in which useful data is stored.

The interface module may further be connected to a database in which templates are coupled to predetermined destinations on the data network by means of a mapping unit (cross-bar).

As a further aspect of the present invention, a system is provided for carrying out electronic business processes based on the interchange of documents. The system has at least two interfaces of the above-mentioned kind in this case, which communicate with each other by means of a data network. Enquiries, acknowledgements of orders, consignment notes, invoices, etc. can thus be transmitted from one interface to the other purely as electronic messages.

Finally, as one further aspect of the present invention, a method is provided of displaying the flow of data between a terminal and a data network such as the internet for example. Interpretation, conversion and transfer of useful data to the terminal and data network take place in this case. There is also processing of the incoming and/or outgoing useful data by means of templates which are stored in a file system, to allow the useful data to be displayed in the form of documents.

Finally, an interface system for connecting systems, heterogeneous ones where required, together via a data network has interface modules which constitute the link between the possibly heterogeneous systems. The data transmission is performed on the basis of transactions by means of defined communications states at the transmitting and receiving ends.

Data is only accepted into the receiving system if all the data in a transaction has been recognised as free of errors.

In a method for connecting systems, heterogeneous ones where required, together via a data network by means of interface modules which constitute the link between the possibly heterogeneous systems, the data transmission is performed on the basis of transactions by means of defined communications states at the transmitting and receiving ends.

Data is only accepted into the receiving system if all the data in a transaction has been recognised as free of errors.

An interface for transmitting useful data on a data network has

a company- and/or sector-specific configuring object which defines processes,

a template object which defines format templates for documents which are used for carrying out business processes defined in the configuring object, and

an interface object which assigns destinations on the data network intended for given processes, to act as partners in the process.

By means of the configuring object, logic links are made between goods/services, document templates, products, customers and suppliers.

The configuring object defines which customer may handle which product.

The format templates have fields for possible useful data.

Where this is required by a business process, format templates can be expanded by dynamic re-loading.

An object-oriented method of transmitting useful data on a data network comprises the following steps:

definition of processes by means of a company- and/or sector-specific configuring object,

definition of format templates by means of a template object, the format templates being used to carry out the business processes defined in the configuring object, and

assignment of given destinations on the data network as partners in the process by means of an interface object.

Other features, advantages and attributes of the present invention will become more clearly apparent from the detailed description of embodiments which will now follow and from reference to the figures in the accompanying drawings.

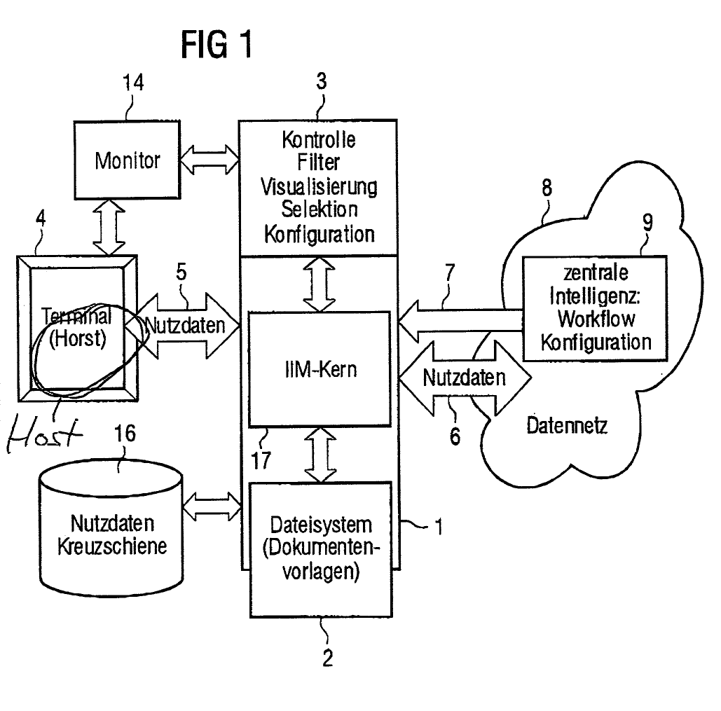

FIG. 1 is a diagrammatic view of the position of an interface module according to the invention in a data network system for carrying out document-based electronic commerce on the basis of transactions,

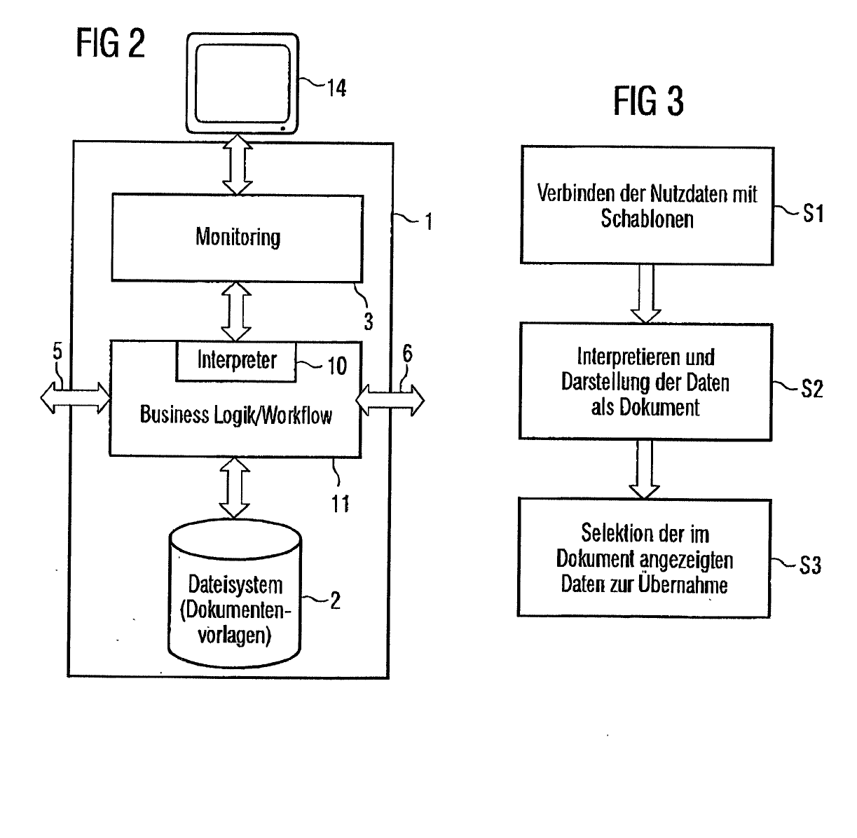

FIG. 2 is a more detailed view of the internal structure of the interface module,

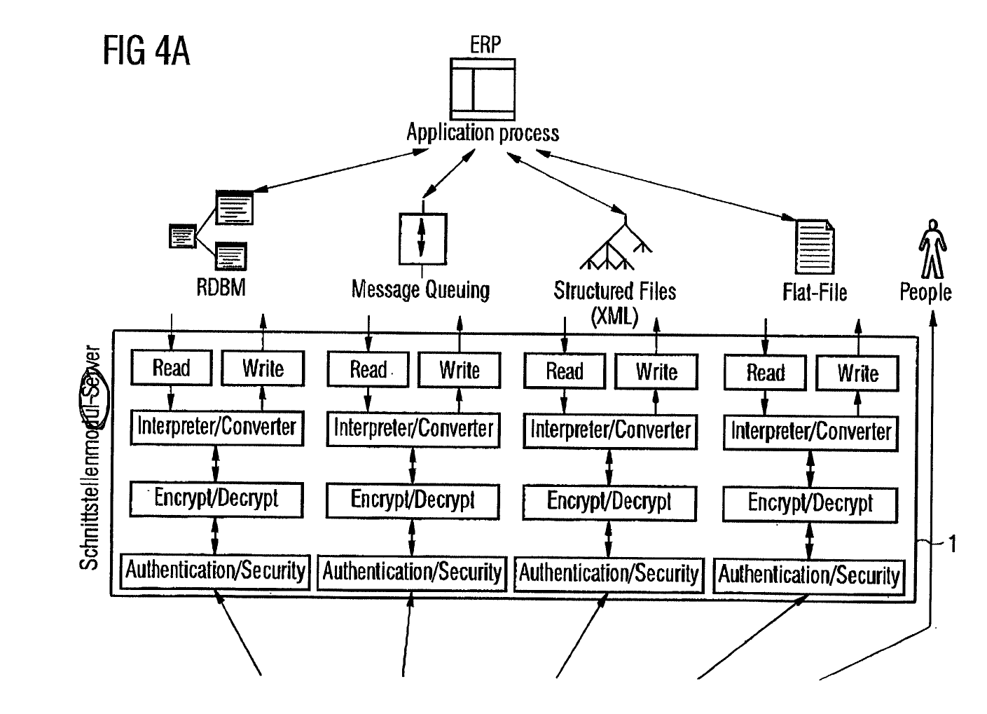

FIG. 3 shows a process for displaying and selecting transmitted data in accordance with the present invention,

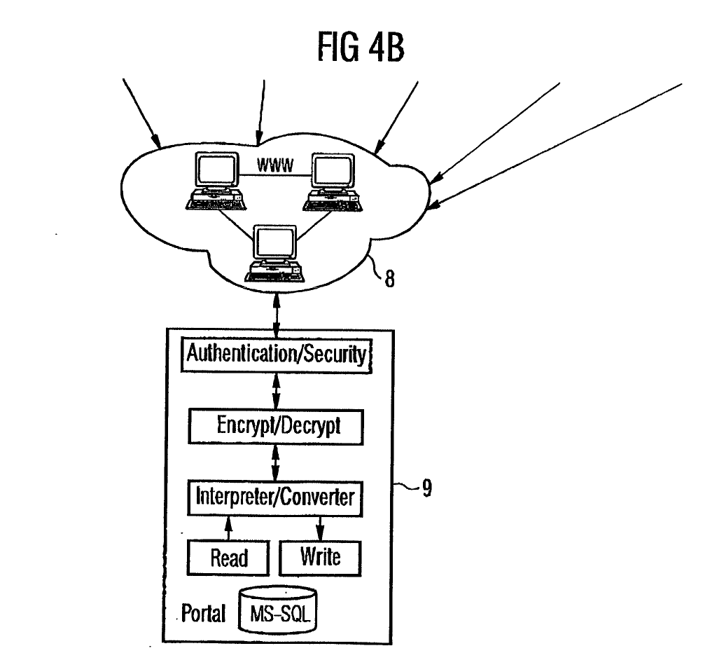

FIG. 4 shows the connection of an interface module to a central portal server,

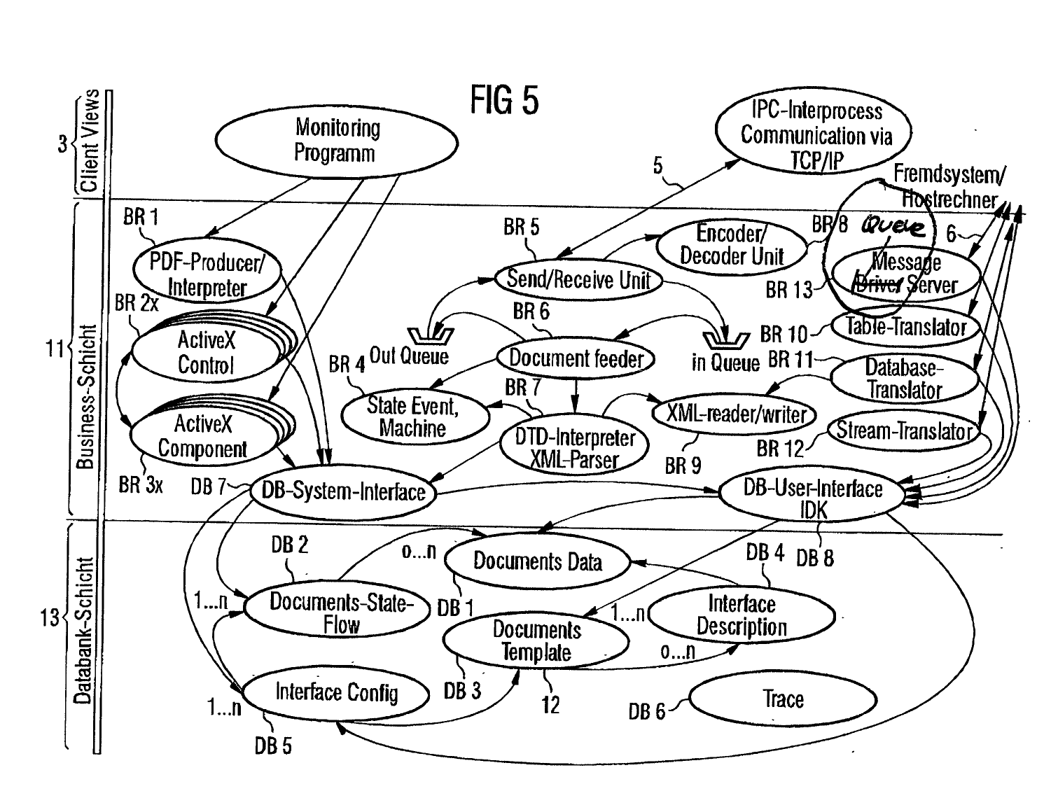

FIG. 5 shows an IT process in the interface module according to the invention,

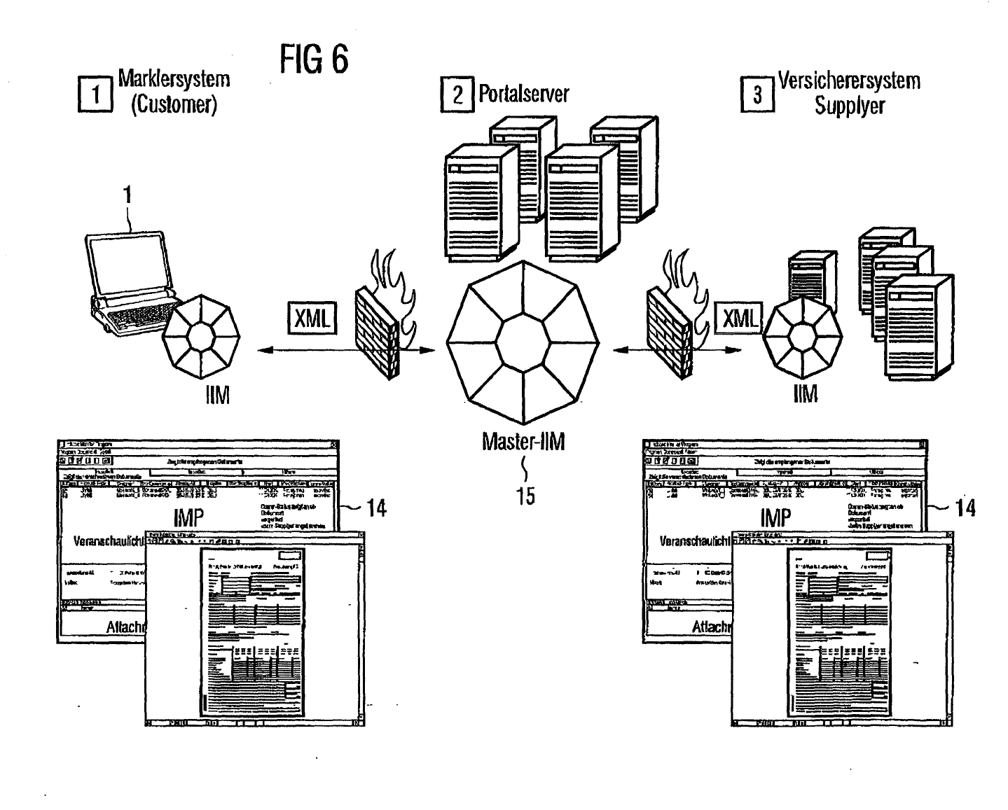

FIG. 6 shows a workflow relating to the display of a data transfer by an interface module according to the invention,

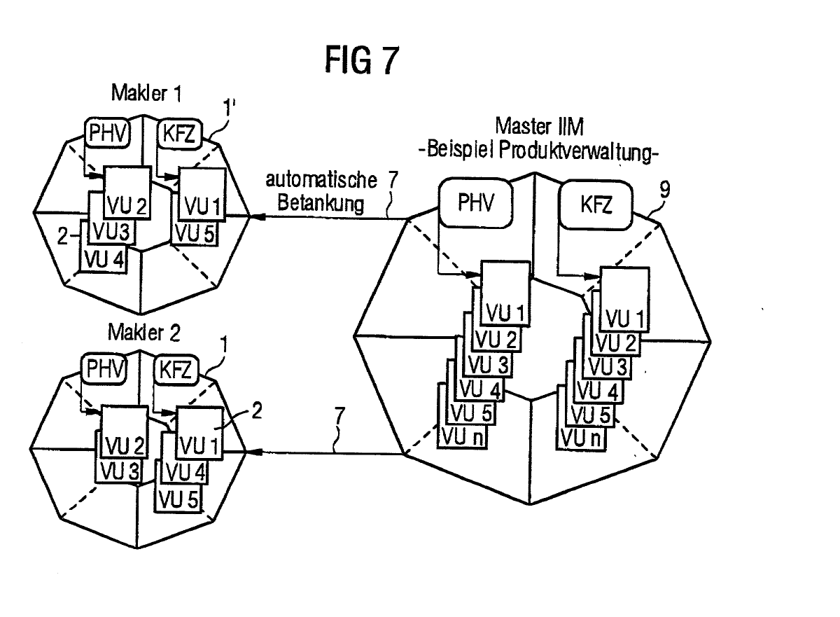

FIG. 7 shows the configuring/updating of interface modules according to the invention by means of a central intelligence on the data network,

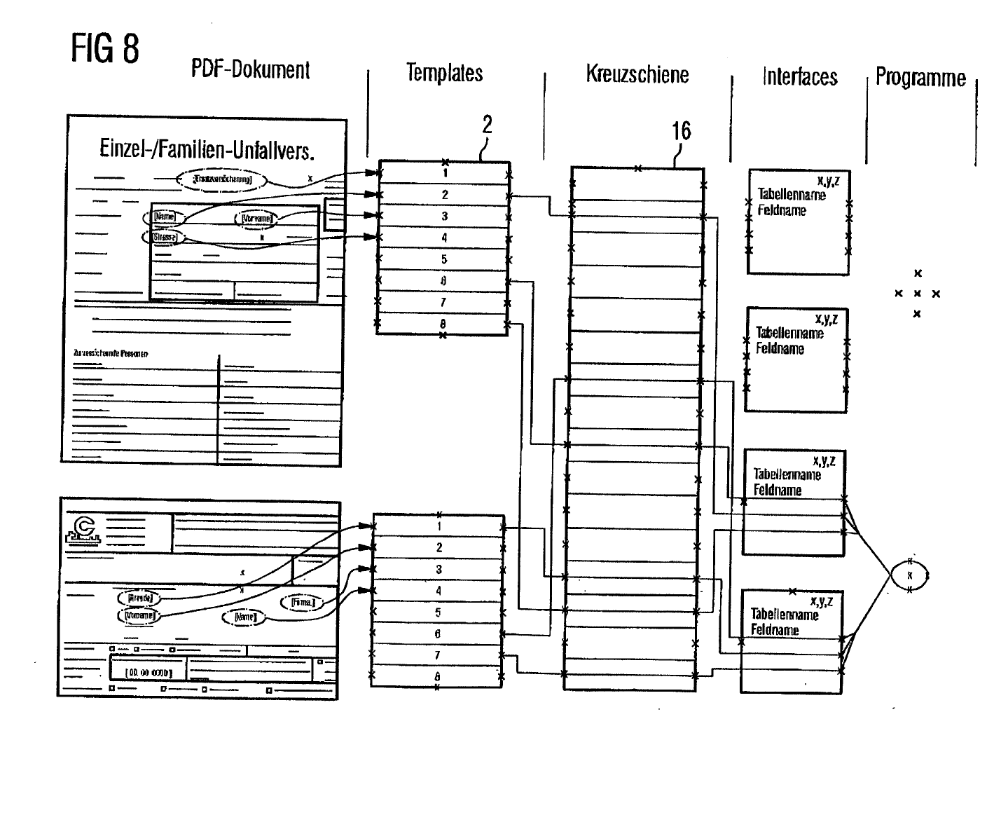

FIG. 8 shows how various document templates can be connected to predetermined destinations on the data network by means of a mapping unit (cross-bar),

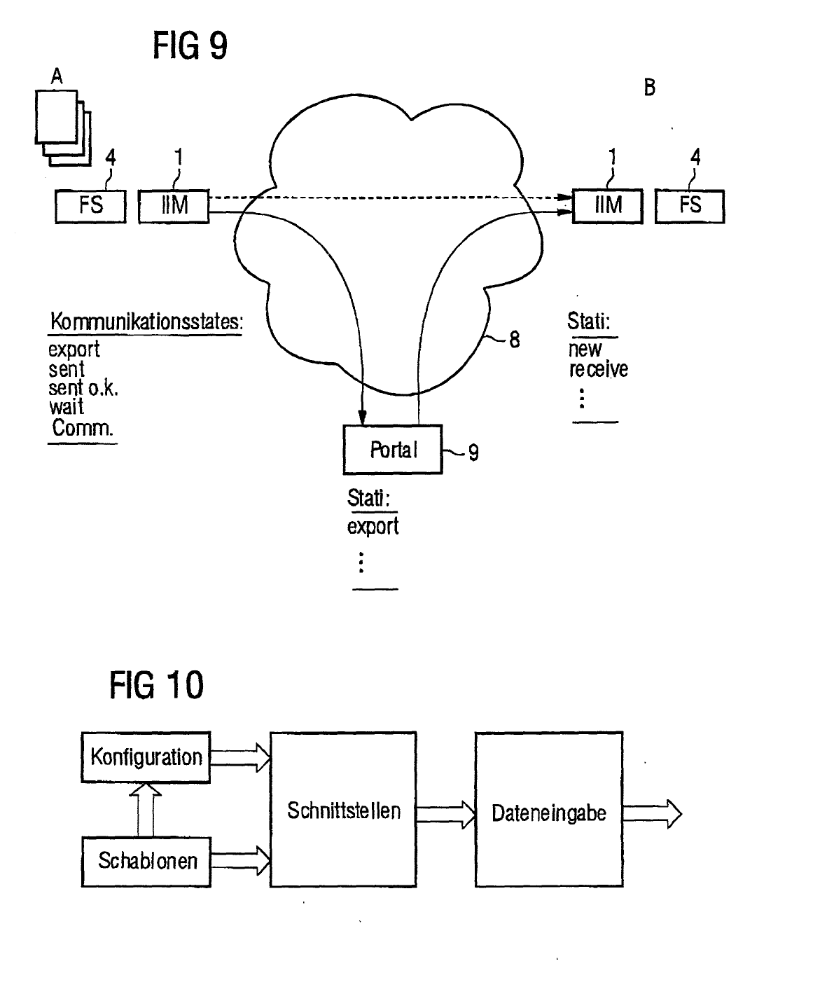

FIG. 9 shows a transaction-based transmission system for connecting systems, heterogeneous ones if required, together according to the present invention,

FIG. 10 is a diagrammatic, object-oriented view of elements of the database layer shown in FIG. 5, and

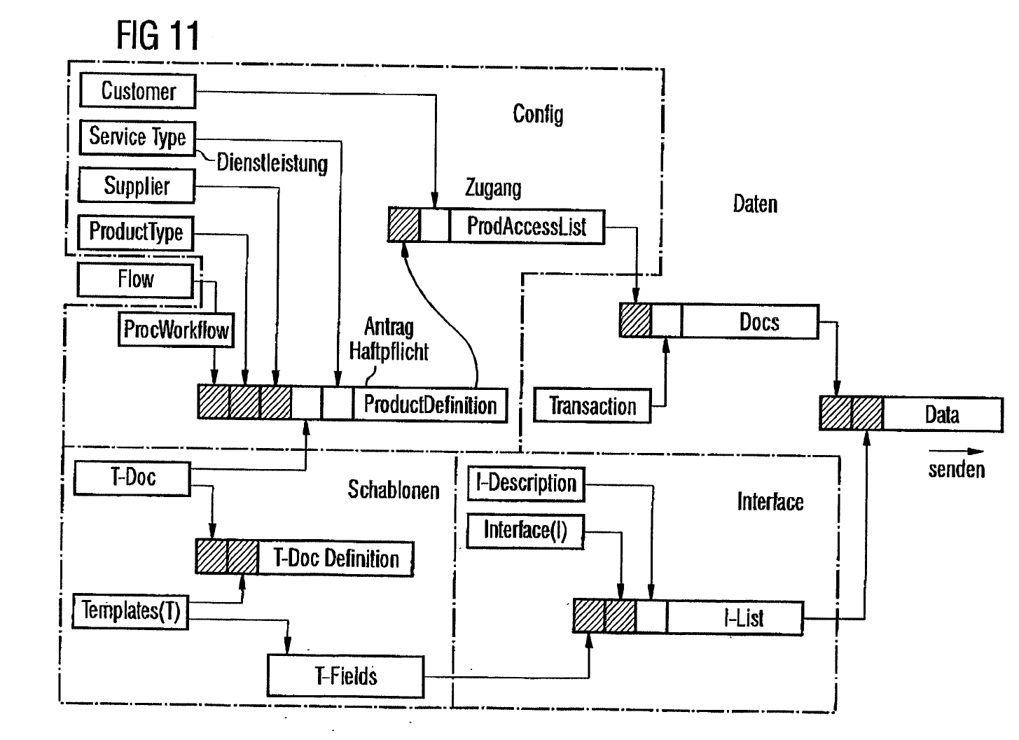

FIG. 11 shows the internal structure of an interface module, from which it can be seen how documents are managed.

Referring to FIGS. 1 and 2, the position of the interface module (IIM) 1 according to the invention in a system for performing document-based electronic commerce will first be explained. The interface module 1 is connected between a terminal (host) 4, belonging to a company for example, and a data network 8, such as the internet for example. By means of the data network 8 it is possible for useful data 6 in particular to be transmitted. The interface module 1 can also transmit useful data 5 to a memory in terminal 4. The useful data 5 may be transmitted in the XML format for example in this case.

Interface module 1 is configurable, in a total of three different ways:

As shown, configuring data can be transmitted from a central intelligence 9 on the data network 8 so that a change can be made to the configuration of, or a workflow in, the interface module 1 from a central point.

The central intelligence 9 may also be another interface module which is connected to the first interface module 1 shown by means of the data network 8. In this way it is possible for business partners for example who have interface modules 1 of this kind to exchange configuring data, such as document templates for example, with one another or to modify the configuring data.

Finally, a further possibility for configuring is for the interface module 1 to configure itself in situ.

The interface module 1 has a file system 2 in which templates 12, in PDF format for example, are stored.

By connecting templates 2 to useful data 6, a checking/filtering/display/selecting/configuring module 3 allows the transmitted useful data 6 to be shown as documents, on a monitor 14 for example.

The connection between the checking/filtering/display/selecting/configuring module 3 and the file system 2 is made in this case by means of a so-called IIM core 17.

Present in a database 16 there may be a mapping unit (“cross-bar”) 16 which assigns predetermined destinations on the data network 8 to given templates 2.

The invention is based in this case on the concept of parallel data holding. The useful data is maintained in situ in the interface module 1 and is matched up with a database, on the central intelligence (portal server) 9 for example. The advantage this has is that the data on the portal server 9 can be used for other services.

Referring to FIG. 3, the process according to the present invention for displaying and selecting useful data that is transmitted will now be explained in detail. In a step S1, data which has been transmitted or is about to be transmitted is connected to templates to allow a document to be generated. In a step S2 the data is interpreted, by means of PDF for example, and shown as a document. Finally, in a step S3, all the useful data in the document shown or only selected parts of it can be accepted (in the case of received useful data) or despatched (in the case of data to be transmitted). This release of data for transmission or acceptance, after selection where appropriate, thus takes place by reference to a display of the useful data in document form.

The following functions amongst others are implemented in the interface module (IIM) 1 according to the invention, as is shown diagrammatically in FIG. 4:

Read

Write

Interpret

Convert

Plausibility check

Store data

Authenticate

Encrypt

Compress

Transmit

Receive

A brief description will now be given of these functions:

Read Depending on the structure of the data, it is read from the input file with the help of a control file, an interface (ODBC) or DTD.

Write Makes the data available in a format able to be read by the outside system.

Interpret Interprets the data read and writes it in the SQL database.

Convert Reads the data from the SQL database and prepares it for the writing operation.

Plausibility check (customer-specific settings) The data acquired can be checked for plausibility to customer-specific requirements. The options available in this case are as follows:

value range (from/to)

conditions

mandatory fields

Store data All transactions are logged continuously and made visible for subsequence tracking.

Authenticate The authentication is based on a Smart Card security scheme. At the portal the user data is verified to an LDAP server (LDAP (Lightweight Directory Access Protocol) is a standardised directory service based on TCP/IP). If the user name and the password are correct, an additional key is generated for the data transfer. If not the user is refused.

Encrypt/decrypt A synchronous key is created for the transmission of the data. From this point in time on, communication takes place by a triple DES encryption process (triple DES is a symmetrical encryption process which is based on the classic DES but uses a key that is twice as long (112 bits). The data to be encrypted is encrypted by a triple combination of the classic DES).

Compress

Before the packets of data are transmitted they are compressed to speed up the transmission.

Transmit The encrypted and compressed data is send direct to the recipient or via the portal. In the process the data is given a status.

Receive The packets of data are received and the other party to the communication is sent an acknowledgement of receipt.

The invention is based on a component object model (COM) which is suitable for the development of component-based software and thus for that of interface module 1. The component object model (COM) was introduced in 1993 by Microsoft. A short time later COM was expanded to include a distributed-object capability: distributed COM (DCOM) allows components to be distributed to various computers on the network.

In the three-layer system architecture according to the present invention, the business processes (“Business Rules”) are moved to the centre Business Rules layer (11 in FIG. 5). The Client layer (3 in FIG. 5) can be kept slim because it simply manages a sort of user interface. It is true that the scheme for the development of IIM 1 is based on a “3-layer system architecture” but it can be expanded to have n-layers. With an expansion to an n-layer architecture, the components of the business layer 11 are distributed to a plurality of computers. This gives a better distribution of the load and an increase in performance. As shown in FIG. 5, IIM 1 is composed of the following layers:

Presentation Layer (Client Layer) 3

generates preset views, e.g. by means of ActiveX (ActiveX is a system interface from the Microsoft company)

provides facilities for remote maintenance of interface module 1 by access to the business layer 11

Business (Business Rules) Layer 11

checks on all transmitting and receiving processes,

controls the data and the document flow (workflow),

is responsible for correct data conversion (outside system/host computer),

allows transactions to be dealt with,

checks changes to configuration,

allows user access to be controlled.

Database Layer (for details see FIGS. 11 and 12)

checks all databases accesses (read, write and new),

distinguishes between useful data, data holdings and configuration data.

Interface module 1 has the following sub-modules:

A. IIM core (17 in FIG. 1) (at the server end, at client end too as an option):

Contains the generic mapping and the generic workflow.

Checks all transactions and data movements and the access authorisations for them.

B. IIB: IIM configuring program 3:

Without any knowledge of programming, this program is used to specify the data interchange, the whole of the workflow and the plausibilities for them for the IIM

C. IMP (monitoring program): IIM user surface for display and administration purposes.

D. IDK (development kit): A development environment with which the IIM can be controlled and configured by calling up simple functions (e.g. Export data to IIM→initWorkList, initExport and Save).

IIB module 3 inserts so-called ActiveX controls into an existing PDF document. The purpose of the controls is to allow the PDF document to be filled in with values. The advantage of the method is that a user is dealing with a product of which he has already had lengthy experience. He is already familiar with for example PDF contracts in hard-copy form and does not have to gain any special knowledge of a program. In another case, such for example as where a broker (as an example of a user) is already working with a broker program, before despatching the data he has entered he can show it to himself again in PDF form by means of presentation layer 3.

Each PDF document is stored in the database layer 13 as a template 12. The templates are used to store rules for interpreting the useful data, in XML format for example. By means of these rules the (automated) processing of transactions becomes possible (which can also include their presentation amongst other things).

A document is thus composed of useful data (XML data for example) and a template, as will be explained in detail later on by reference to FIG. 11. The fields themselves in a template are managed and maintained in the file layer 13.

Intelligence can be stored in the file system 2 with the assistance of a so-called “builder”. The way this works is for example that a range of values is assigned to a field. If this range is exceeded or not reached, there is an error message which tells the user to change the value in question. What can also be stored however are logic links for template fields.

By reference to FIG. 6, the invention will now be explained as applied to a DP system belonging to an insurance broker.

IIM 1 is the interface to a broker management program (IMP). IIM 1 reads all the defined data from the IMP. Stored in IIM 1 are workflow templates for each defined process. These templates can be called up individually and are displayed via the IMP.

In the workflow document, where plausibilities are defined (e.g. mandatory fields), additions can be made, i.e. further data can be added in. Hence it is not necessary for conformity of data to exist between two DP systems that are communicating. Example: an insurer (as an example of a supplier) defines the data required for a given process. This data is displayed by means of a workflow document/workflow template. The broker (customer) transmits the data he already has stored on his system to the workflow document. If the plausibilities defined in the workflow document call for more data than the broker has stored on his system, then he can add to the data.

The data is packed (converted) by IIM 1 in an XML format. It can be buffer-stored in IIM 1 and transmitted to the platform server 8 (central intelligence) at any time.

The broker sees what process data has been sent and what received.

Received data can be displayed before being accepted onto the in-house system. The acceptance of the data can be defined as individual acceptance or routine batch runs.

Reference will now be made to FIG. 7. In this example all the product and user management takes place on a portal server. Particularly where there is direct communication between two interface modules, the product and user management may on the other hand take place, alternatively or in addition, in the interface modules themselves (see FIGS. 11 and 12):

Supplier

Customer

Supplier's workflow documents (products)

All document statuses

The portal server (master IIM) 9 knows which documents (templates and products) are stored or held in the particular supplier and customer IIM's.

The master IIM 9 can carry out an automatic “fuelling” operation, i.e. can transmit workflow documents to the supplier and customer IIM 1's.

Communication between the master IIM 9 and the supplier and customer IIM's takes place with a security system applied. Authentication is performed by a smart card scheme and triple DES encryption.

FIG. 8 shows a so-called cross-bar 16 which can be stored in a database, for example on the portal server 9. Templates 2 represent a specific grouping of defined fields in for example a PDF document. Defined in the cross-bar 16 are the logic links (pictures) of the templates to the correct destinations at the appropriate interfaces (often referred to as “mapping”). The relationships between the templates 2 and the interfaces are specified in this way. A template 2 can have a plurality of interfaces associated with it. An insurance company for example can make its products available to a plurality of different brokers. The latter generally have heterogeneous environments, which means that a plurality of interfaces specific to these environments have to be provided.

The interfaces are responsible for connecting the interface module up to the outside system at the terminal. On the insurance market for example exists an enormous diversity of systems. In the case of an insurance company for example, the interface itself is provided by a broker management program or is created in collaboration with software specialists from the company concerned. The broker management programs feed these interfaces from their interfaces and also read the data out of them again to supply it to the broker management program (the same is true at the insurer's end).

Details of the implementation of the process illustrated in FIG. 8 will be explained later on with reference to FIGS. 10 and 11.

The features and attributes of the present invention can be summarised as follows:

1. IIM 1 connects a plurality of computers (or hosts) together for the interchange of data.

2. The interchange of data always takes place on the basis of transactions (secure transmission)

3. All transactions and documents can be displayed at will (the format used in this case is for example the PDF standard).

4. Rigorous authentication (optional) and data encryption (optional) are already included in IIM 1.

5. IIM 1 operates on the customer and supplier principle and in this case the supplier and customer can have entirely different EDP structures.

6. If desired more recent versions of data and documents can be supplied automatically between supplier and customer (this ensures that the data and documents being worked with are up to date).

7. The connection of computers or hosts or applications having an IIM 1 to the outside world gives the user of this interface a 1*m relationship (without the IIM there would be n−m interfaces, i.e. the user would have to implement n interfaces).

Referring to FIG. 9, the aspect of the present invention that will now be explained is that all the document-based transmissions of data take place on the basis of transactions. In FIG. 9, a document-based electronic business process is to be dealt with between a user A and a user B. Each of the users A and B has an interface module 1 which is connected between the terminal (FS=Fremdsystem=outside system) 4 of each user and the data network 8. As can be seen from FIG. 9, an interchange of data can take place either indirectly via platform server 9 or directly between the two interface modules 1.

The (indirect) interchange of data by means of the platform server can be described as the star model where a large business partner or an organisation (termed “parent & master” in the present case) lays down standards for its commercial partner, such as the document formats and interchange protocols used for example. A so-called repository (a system for storing sources for programs and documents), which in practice is generally a database, is thus situated at the “parent/master”, which means that the “children” have to obtain the information they need from there.

The direct interchange between two interface modules on the other hand follows a sort of “ad hoc” model. In this case the smaller business partners set up their own so-called “ad hoc” interactions each time. Hence various databases/repositories are not stored centrally at a parent/master but are distributed among the users.

Data transmission by means of the interface module 1 according to the present invention, or to be more exact the transmission of data from an interface module 1 to another interface module 1 connected to the data network 8 or to a central portal server, takes place on the basis of transactions. What this means is that data for transmission is grouped together into transactions. If an error is found at the recipient end when the data in a transaction is transmitted, all the data belonging to a transaction is rejected. Only when all the data in a transaction is recognised to be free of errors does the recipient accept the dataset making up the transaction and write it into, for example, its database.

Transactions may be data relating to a single document but also data relating to a plurality of documents in this case, with the sequence of the plurality of documents representing one unit of the electronic business process. This being the case a transaction may also comprise a sequence of documents to be sent to and fro. For the business process “policy issue”, an example from the insurance industry, the workflow steps “Application” and “policy issue” for example are required, each of these workflow steps being mapped as documents. The combination of the “Application” document to be transmitted in a first direction and the “Policy issue” document to be sent back can usefully be grouped together into a transaction.

Each transaction also has an individual transaction number which identifies it.

Provided in each interface module 1 and where required in the platform server are so-called communication states which show the communication status of a transaction. At the transmitting end (user A), these communication states look like this for example:

Export

Send

Sent O.K.

Wait

Commit

At the receiving end (platform or user B), they can therefore look like this:

New

Receive

Received O.K.

Wait

Commit.

A transaction is rejected if there is an error in one of the communication states. The process then continues in a defined state. At the transmitting end the process can for example revert to the “Send” state. What is important however is that at the receiving end the useful data is only accepted if the last communication state for a transaction has been assessed as free of errors.

For connecting heterogeneous systems together, the software of the interface modules 1 observes the following criteria:

Simple and quick implementation

Flexible interface

Able to be used in a heterogeneous system environment

Easy to maintain

Expandable

Process-oriented

Data can be checked for plausibility

Security

Own database.

The outside system (terminal 4) is generally fitted with at least one of the following interfaces:

DB or Excel tables able to be accessed via ODBC (open database connectivity) or ADO (abstract data object)

Structured data (XML files)

Flat files (files which contain only directly interpretable data)

Input by the account manager or employee. The import and export of data has to be controlled by the business logic of the ERP (Enterprise Resource Planning, software solutions which control and evaluate the business management process in the fields of production, marketing, logistics, finance, personnel, etc.), to which the database is subordinated.

The import or export of data between an outside system and another outside system can be performed in two different ways. Example: The export of data can take place via an ODBC access whereas the import of data is performed via a flat file.

FIG. 10 is a diagrammatic view of the internal structure of the database layer (13 in FIG. 5) of an interface module from which the management of documents can be seen. FIG. 11 is a detail view showing the operation of FIG. 11. Back-references will again be made to the corresponding illustration in Fig. B.

As can be seen from FIG. 10, the essential elements of the database or file layer 13 organised as an object model are:

a configuring object (corresponds to the “Interface config” object in FIG. 5),

a template object (corresponds to the “Document templates” object in FIG. 5), and

an interface object (corresponds to the “Interface description” object in FIG. 5).

The configuring object and the interface object access the template object each time in this case.

Details of FIG. 10 will now be explained by reference to FIG. 11.

In the “Flow” object (corresponds to the “Documents state/flow” object in FIG. 5), the customer-specific processes and their dependences are defined. This “Flow” object is configured to map the appropriate company- and/or sector-specific business processes and their sequences. What is also laid down in the “Flow” object is whether, and if so within what time-span, replies (or the type and content of these) are expected after data has been transmitted.

The “Product definition” object is the cross-bar for the document templates. The associated template is assigned as a function of the parameters “Service type”, “Supplier”, “Product type” and “Flow”. An example of a product definition is an application to a predetermined insurance company (supplier) for a motor vehicle third-party insurance (product type).

Laid down in the “Access list” is which customer can handle which product (as defined in the product definition).

The product definition can also relate to a part-product. If for example the complete product is to be motor vehicle third-party insurance, the part products could be “New application”, “Policy issue in response to application” or “Accident report”. Certain customers may thus be allowed access only to parts of the complete product.

The templates have fields or T-fields for possible useful data (see also FIG. 8).

The “T-Fields” in FIG. 11 represent the individual fields. Templates group together a plurality of T-fields under one name. The template doc (“T-Doc”) in FIG. 11 is a standard format template for a form. In a simple case the T-doc is defined as equalling a (part) product. This is the case when for example known forms used by insurance companies are electronically converted “one to one”. The part product “New application” may then correspond exactly to a given form for example. Generally speaking however it is also possible for a T-doc to comprise a plurality of templates. This is for example the case when a plurality of forms are needed for one part product.

The “T-Doc Definition” can be used to allow templates to be dynamically reloaded in accordance with predetermined criteria (number of insureds, etc.). In this way, by re-loading templates a number of times, it is possible to obtain templates of quite large size by means of a relatively simple definition. This is necessary if for example the basic form is designed for a maximum number of insureds but more persons to be insured need to be specified, which is done by dynamically re-loading a template, more than once if necessary.

Stored in the “Interface Description” are the meta-data on the outside system, such as the data on the local broker management system for example. The various T-fields are “referenced” in the “I-List”. What are laid down in this way in the I-list are how the T-fields are actually to be treated and utilised to suit the needs of the outside system.

Transactions are defined in “Docs”. The data on certain part products (product definition) is assigned by means of the Docs.

1. Interface system for connecting systems, heterogeneous ones where required, together via a data network, wherein the system has interface modules which represent the link between the possibly heterogeneous systems, and the transmission of data takes place on the basic of transactions by means of defined communications stations at the transmitting and receiving ends.

2. Interface system according to claim 1, characterised in that data is only accepted into the receiving system if all the data in a transaction has been recognised as free of errors.

3. Method of connecting systems, heterogeneous ones where required, together via a data network by means of interface modules which represent the link between the possibly heterogeneous systems, characterised in that the data transmission is performed on the basis of transactions by means of defined communications states at the transmitting and receiving ends.

4. Method according to claim 3 characterised in that data is only accepted into the receiving system if all the data in a transaction has been recognised as free of errors.

5. Interface for transmitting useful data on a data network, having:
a company- and/or sector-specific configuring object which defines processes,
a template object which defines format templates for documents which are used for carrying out business processes defined in the configuring object, and
an interface object which assigns destinations on the data network intended for given processes, to act as partners in the processes.

6. Interface according to claim 5, characterised in that by means of the configuring object, logic links are made between goods/services, document templates, products, customers and suppliers.

7. Interface according to claim 5 or 6, characterised in that the configuring object defines which customer may handle which product.

8. Interface according to one of claims 5 to 7, characterised in that the format templates have fields for possible useful data.

9. Interface according to one of claims 5 to 8, characterised in that where this is required by a business process, format templates can be expended by dynamic re-loading.

10. Object-oriented method of transmitting useful data on a data network, having the following steps:
definition of processes by means of a company- and/or sector-specific configuring object,
definition of format templates by means of a template object, the format templates being used to carry out the business processes defined in the configuring object, and
assignment of given destinations on the data network as partners in the process by means of an interface object.

11. Method according to claim 10, characterised in that logic links are made between goods/services, document templates, products, customers and suppliers by means of the configuring object.

12. Method according to claim 10 or 11, characterised in that the configuring object defines which customer may handle which product.

13. Method according to one of claims 10 to 12, characterised in that the format templates have fields for possible useful data.

14. Method according to one of claims 10 to 13, characterised in that where this is required by a business process, format templates can be expended by dynamic re-loading. characterised in that

15. Computer software program, characterised in that it implements a method according to one of claims 3, 4 or 10 to 14 when it is run on a computing means.
